(19) United States
(12) Patent Application Publication
(10) Pub. No.: US 2017/0240410 A1
(43) Pub. Date: Aug. 24, 2017

(54) DRINKING LIQUID COOLING SYSTEM

(71) Applicant: C-ONE Global Co., Ltd., Gimpo-si (KR)

(72) Inventor: Deok Hyun KIM, Gimpo-si (KR)

(73) Assignee: C-ONE Global Co., Ltd., Gimpo-si (KR)

(21) Appl. No.: 15/152,303

(22) Filed: May 11, 2016

(30) Foreign Application Priority Data
Feb. 24, 2016 (KR) 10-2016-0022169

(51) Int. Cl. B67D 1/08; B67D 1/14; B67D 1/00; F25D 31/00; F25D 3/00

(52) U.S. Cl. CPC B67D 1/0857; F25D 31/003; F25D 3/005; B67D 1/0009; B67D 1/0884; B67D 1/1477; F25D 2700/16; F25D 2600/04

(57) ABSTRACT

The present disclosure provides a drinking liquid cooling system comprising: a first cooler configured to cool drinking liquid; a second cooler configured to allow the drinking liquid from the first cooler to have a pre-defined temperature; and a drinking liquid guider configured to guide the drinking liquid via the first cooler and, then, via the second cooler and, then, to allow the drinking liquid to be discharged.

### CROSS-REFERENCE TO RELATED APPLICATION

This application claims the benefit of Korea Patent Application No. 10-2016-0022169 filed on Feb. 24, 2016 the entire content of which is incorporated herein by reference for all purposes as if fully set forth herein.

### BACKGROUND

Field of the Present Disclosure

The present disclosure relates to a drinking liquid cooling system, and, more particularly, to a drinking liquid cooling system to continuously supply drinking liquid with constant temperature even in supply of much drinking liquid.

Discussion of the Related Art

Generally, a cooling apparatus may cool drinking liquids such as beer, wine, or purified water, etc. to supply them in a cooled state to the user.

The drinking liquid cooling system may include a housing having a receipt space formed therein, and a water reservoir in the space to contain therein cooling water. On one side of the reservoir, a compressor and condenser may be disposed to compress and condense a refrigerant. Within the reservoir, a refrigerant pipe may be disposed, through which the refrigerant flows to cool the cooling water. Further, a drinking liquid pipe is dipped in a circulating manner into the cooling water. Thus, the drinking liquid may be cooled.

Using the conventional drinking liquid cooling system, when the drinking liquid is discharged by an amount above a given amount, the drinking liquid may be poorly cooled. Thus, there is a need to solve this problem.

One exemplary prior art document is as follows: Korean Patent application laid-open number 2011-0021190 published on Mar. 4, 2011 and titled as “Dispenser Tower”.

This “Background” section is provided for background information only. The statements in this “Background” section are not an admission that the subject matter disclosed in this “Background” section constitutes prior art to the present disclosure, and no part of this “Background” section may be used as an admission that any part of this application, including this “Background” section, constitutes prior art to the present disclosure.

### SUMMARY

From considerations of the above situations, the present disclosure provides a drinking liquid cooling system to continuously supply drinking liquid with constant temperature even in a supply of much drinking liquid.

In one aspect, the present disclosure provides a drinking liquid cooling system comprising: a first cooler configured to cool drinking liquid; a second cooler configured to allow the drinking liquid from the first cooler to have a pre-defined temperature; and a drinking liquid guider configured to guide the drinking liquid via the first cooler and, then, via the second cooler and, then, to allow the drinking liquid to be discharged.

In one embodiment, the first cooler comprises: a first water reservoir configured to contain therein a first cooling water, and allow the drinking liquid guider to pass therethrough; and a first heat exchanger module configured to cool the first cooling water.

In one embodiment, the second cooler comprises: a second water reservoir configured to contain therein a second cooling water, and allow the drinking liquid guider to pass therethrough; and a second heat exchanger module configured to allow the second cooling water to have the pre-defined temperature.

In one embodiment, the drinking liquid guider comprises: a first guide cooler received in the first water reservoir, and contacting the first cooling water; a second guide cooler received in the second water reservoir, and contacting the second cooling water; a guide connector configured to connect the first guide cooler and the second guide cooler with each other, and, thus, to guide the drinking liquid from the first guide cooler to the second guide cooler; a drinking liquid supply coupled to the first guide cooler to supply the drinking liquid to the first guide cooler; and a drinking liquid discharger coupled to the second guide cooler to discharge the drinking liquid.

In one embodiment, each of the first guide cooler and the second guide cooler has inner and outer spirally-extending structures, wherein the inner and outer spirally-extending structures are spaced from each other.

In one embodiment, the guide connector comprises: a connection pipe having both open ends coupled to the first guide cooler and the second guide cooler respectively; and connection fasteners, each connection fastener being configured to fasten the both ends of the connection pipe to the first guide cooler and the second guide cooler respectively.

In one embodiment, the guide connector comprises: a sensor embedded in the connection pipe and configured to sense a temperature of the drinking liquid currently passing through the connection pipe; a controller configured to receive the sense temperature from the sensor; and a valve mounted to the connection pipe, and configured to open or close the connection pipe under control of the controller.

In one embodiment, the second heat exchanger module is configured to adjust a temperature of the second cooling water under control of the controller.

Using the drinking liquid cooling system in accordance with one embodiment of the present disclosure, drinking liquid may be rapidly cooled by the first cooler, and, then, may reach the pre-defined temperature using the second cooler. Thus, the user may always have drinking liquid with a constant temperature.

With the drinking liquid cooling system in accordance with one embodiment of the present disclosure, each of the first guide cooler and the second guide cooler may have inner and outer spirally-extending structures, wherein the inner and outer spirally-extending structures are spaced from each other. This may allow the first guide cooler and the second guide cooler to have enlarged contact areas with the first cooling water and the second cooling water respectively. Thus, a thermal conductance therebetween may be enhanced.

Using the drinking liquid cooling system in accordance with one embodiment of the present disclosure, the sensor may sense the temperature of drinking liquid currently passing through the connection pipe and send the same to the controller, and, then, the controller may instruct the valve to open or close the connection pipe based on the measured temperature.

### BRIEF DESCRIPTION OF THE DRAWINGS

A brief description of each drawing is provided to more fully understand the drawings, which is incorporated in the detailed description of the disclosure.

FIG. 1 illustrates a schematic view of an appearance of a drinking liquid cooling system in accordance with one embodiment of the present disclosure.

FIG. 2 illustrates a view of an internal configuration of a drinking liquid cooling system in accordance with one embodiment of the present disclosure.

FIG. 3 illustrates a schematic view of a first cooler of a drinking liquid cooling system in accordance with one embodiment of the present disclosure.

FIG. 4 illustrates a schematic view of a second cooler of a drinking liquid cooling system in accordance with one embodiment of the present disclosure.

FIG. 5 illustrates a schematic view of an integration between a first cooler and a second cooler of a drinking liquid cooling system in accordance with one embodiment of the present disclosure.

FIG. 6 illustrates a schematic view of a drinking liquid guider of a drinking liquid cooling system in accordance with one embodiment of the present disclosure.

FIG. 7 illustrates a schematic view of a first guide cooler and a second guide cooler of a drinking liquid cooling system in accordance with one embodiment of the present disclosure.

FIG. 8 illustrates a schematic view of a guide connector of a drinking liquid cooling system in accordance with one embodiment of the present disclosure.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Further, all numbers expressing dimensions, physical characteristics, and so forth, used in the specification and claims are to be understood as being modified in all instances by the term “about”. Accordingly, unless indicated to the contrary, the numerical valves set forth in the following specification and claims can vary depending upon the desired properties sought to be obtained by the practice of the present disclosure. Moreover, all ranges disclosed herein are to be understood to encompass any and all subranges subsumed therein. For example, a stated range of “1 to 10” should be considered to include any and all subranges between (and inclusive of) the minimum valve of 1 and the maximum valve of 10; that is, all subranges beginning with a minimum valve of 1 or more and ending with a maximum valve of 10 or less, e.g., 1 to 6.3, or 5.5 to 10, or 2.7 to 6.1.

As used herein, the term “substantially,” “about,” and similar terms are used as terms of approximation and not as terms of degree, and are intended to account for the inherent deviations in measured or or calculated valves that would be recognized by those of ordinary skill in the art. Further, the use of “may” when describing embodiments of the present disclosure refers to “one or more embodiments of the present disclosure.”

Hereinafter, various embodiments of the present disclosure will be described in details with reference to attached drawings.

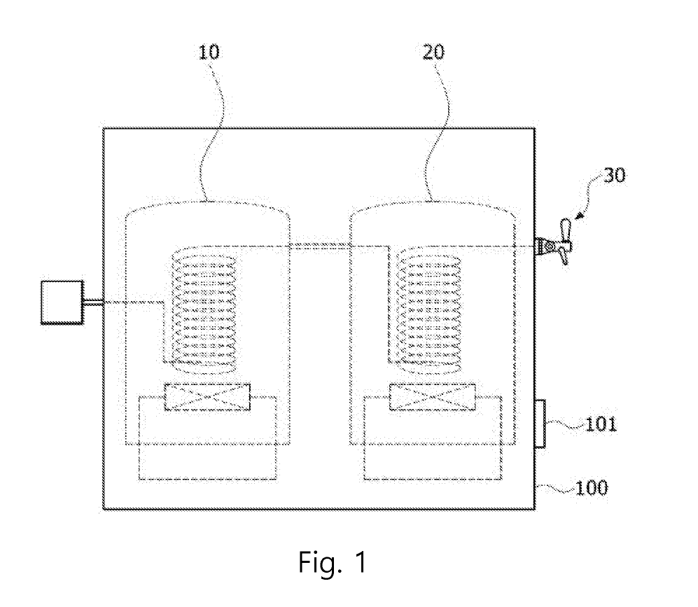

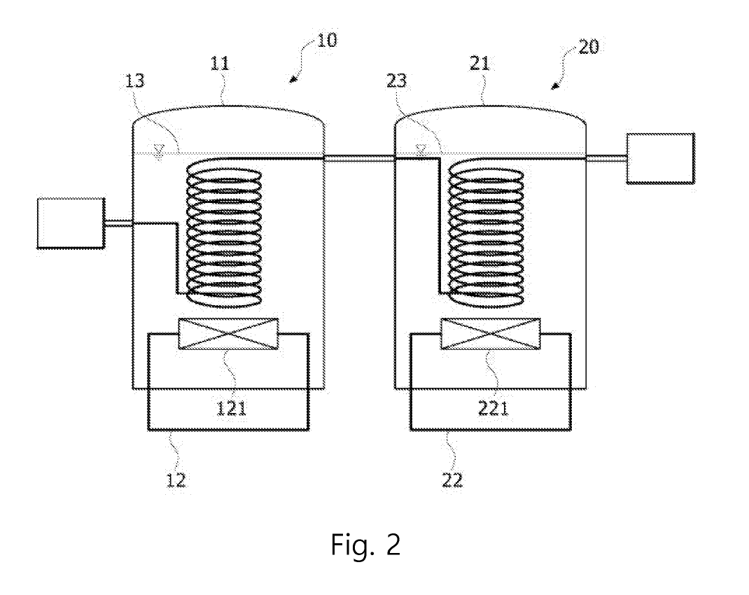

FIG. 1 illustrates a schematic view of an appearance of a drinking liquid cooling system in accordance with one embodiment of the present disclosure. FIG. 2 illustrates a view of an internal configuration of a drinking liquid cooling system in accordance with one embodiment of the present disclosure. Referring to FIG. 1 and FIG. 2, a drinking liquid cooling system 1 in accordance with one embodiment of the present disclosure may include a first cooler 10, a second cooler 20, and a drinking liquid guider 30. The drinking liquid cooling system 1 may be configured to supply a cooled drinking liquid or beverage including, but not limited thereto, beer, wine, purified water.

The first cooler 10 may first cool drinking liquid. The second cooler 20 may adjust a temperature of the cooled drinking liquid from the first cooler 10 to a pre-defined temperature. The first cooler 10 and the second cooler 20 may be received in a housing 100.

The drinking liquid guider 30 may be configured to guide drinking liquid from a drinking liquid drinking liquid supply via the first cooler 10 and then the second cooler 20 to a drinking liquid outlet.

In this way, drinking liquid may be rapidly cooled via the first cooler 10, and then, may have the pre-defined temperature via the second cooler 20, and, then, may be discharged via the outlet. In this connection, the pre-defined temperature may be set as a default in a manufacturing of the present drinking liquid cooling system or may be adjusted by the user. In order for the user to adjust the pre-defined temperature, a temperature controller 101 may be mounted on the housing 100 to control operations of the first and second coolers 10 and 20.

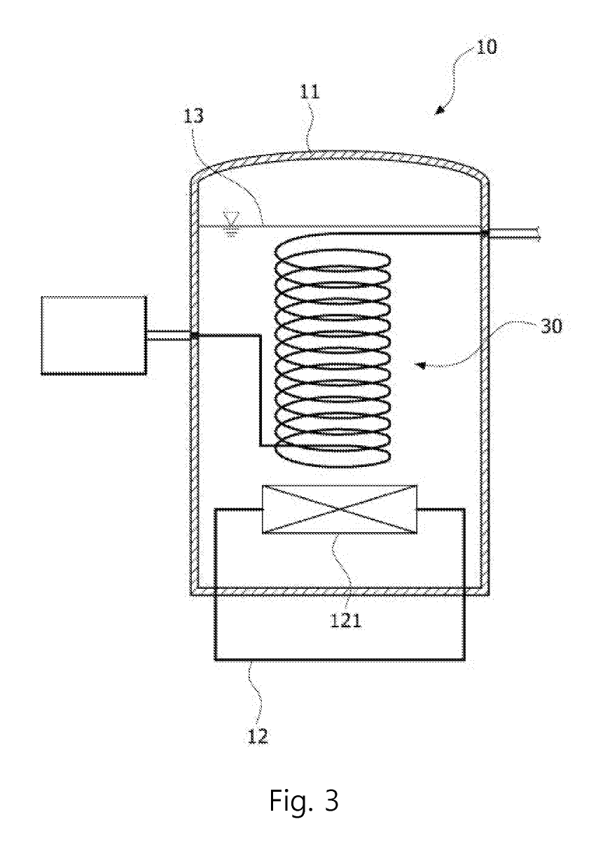

FIG. 3 illustrates a schematic view of a first cooler of a drinking liquid cooling system in accordance with one embodiment of the present disclosure. Referring to FIG. 1 to FIG. 3, the first cooler 10 in accordance with one embodiment of the present disclosure may include a first water reservoir 11 and a first heat exchanger module 12.

The first water reservoir 11 may contain therein first cooling water 13. The drinking liquid guider 30 may pass through the first water reservoir 11. The first heat exchanger module 12 may be configured to cool the first cooling water 13. In one example, the first cooling water 13 may be embodied as cooling water containing ices therein. The first heat exchanger module 12 may have a first heat exchanger 121 embedded in the first water reservoir 11 to exchange heat with the first cooling water 13 itself. In an alternative, the first heat exchanger 121 may be mounted on an outer wall of the first water reservoir 11 to exchange heat with the first water reservoir 11. By the first heat exchanger module 12, the first cooling water 13 may be cooled, which, in turn, may rapidly cool drinking liquid within the drinking liquid guider 30 dipped in the first cooling water 13. It may be appreciated that the first heat exchanger module 12 may include a compressor the for heat exchange. Details about the compressor may be omitted as well known to the skilled person to the art.

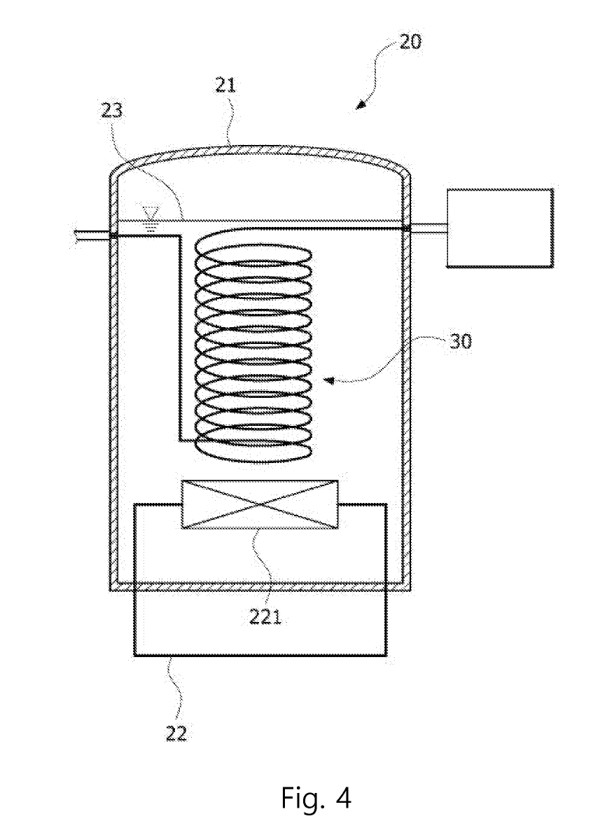

FIG. 4 illustrates a schematic view of a second cooler of a drinking liquid cooling system in accordance with one embodiment of the present disclosure. Referring to FIG. 1 to FIG. 4, the second cooler 20 in accordance with one embodiment of the present disclosure may include a second water reservoir 21 and a second heat exchanger module 22.

The second water reservoir 21 may contain therein second cooling water 23. The drinking liquid guider 30 may pass through the second water reservoir 21. The second heat exchanger module 12 may be configured to adjust the temperature of drinking liquid in the second cooler 20 using the second cooling water 23. In one example, the second cooling water 13 may be embodied as cooling water. The second heat exchanger module 22 may have a second heat exchanger 221 embedded in the second water reservoir 21 to exchange heat with the second cooling water 23 itself. In an alternative, the second heat exchanger 221 may be mounted on an outer wall of the second water reservoir 21 to exchange heat with the second water reservoir 21. By the second heat exchanger module 22, the temperature of the second cooling water 13 may be adjusted to the pre-defined temperature. Thus, the drinking liquid within the drinking liquid guider 30 dipped in the second cooling water 23 may have the pre-defined temperature. It may be appreciated that the second heat exchanger module 22 may include a compressor the for heat exchange. Details about the compressor may be omitted as well known to the skilled person to the art.

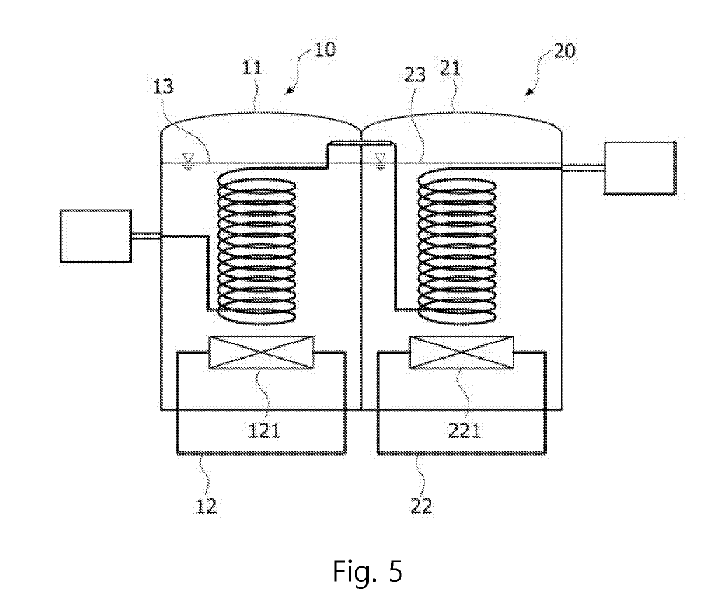

FIG. 5 illustrates a schematic view of an integration between a first cooler and a second cooler of a drinking liquid cooling system in accordance with one embodiment of the present disclosure. Referring to FIG. 1 to FIG. 5, the first water reservoir 11 and the second water reservoir 21 may be separately received in the housing 100. In an alternative, the first water reservoir 11 and the second water reservoir 21 may be integrated with each other. When the first water reservoir 11 and the second water reservoir 21 is integrated with each other, a partition wall may be formed between the first water reservoir 11 and the second water reservoir 21. Further, the drinking liquid guider 30 may pass through the partition wall.

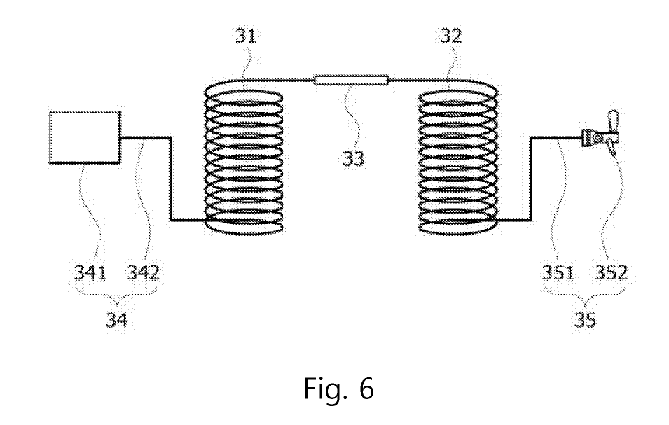

FIG. 6 illustrates a schematic view of a drinking liquid guider of a drinking liquid cooling system in accordance with one embodiment of the present disclosure. Referring to FIG. 1 to FIG. 6, the drinking liquid guider 30 in accordance with one embodiment of the present disclosure may include a first guide cooler 31 and, a second guide cooler 32, a guide connector 33, a drinking liquid supply 34, and a drinking liquid discharger 35.

The first guide cooler 31 may be received in the first water reservoir 11 and may contact the first cooling water 13. In one example, the first guide cooler 31 may be made of a thermally conductive material. In one example, the first guide cooler 31 may be formed of a pipe to allow drinking liquid to pass therethrough. The first guide cooler 31 may be dipped in the first cooling water 13. Thus, via heat exchange between the first cooling water 13 and drinking liquid, the latter may be rapidly cooled.

The second guide cooler 32 may be received in the second water reservoir 21 and may contact the second cooling water 23. In one example, the second guide cooler 32 may be made of a thermally conductive material. In one example, the second guide cooler 32 may be formed of a pipe to allow drinking liquid to pass therethrough. The second guide cooler 31 may be dipped in the first cooling water 13. Thus, via heat exchange between the second cooling water 23 and drinking liquid, the latter may have the pre-defined temperature.

The guide connector 33 may enable a connection between the first guide cooler 31 and the second guide cooler 32. Thus, the guide connector 33 may transfer drinking liquid from the first guide cooler 31 to the second guide cooler 32. The guide connector 33 may be disposed at top portions of the first water reservoir 11 and the second water reservoir 21.

The drink liquid supply 34 may be coupled to the first guide cooler 31, and, thus, may allow drinking liquid to be fed to the first guide cooler. In one example, the drinking liquid supply 34 may include a drinking liquid storage 341 to store therein drinking liquid, and a supply pipe 342 to allow a connection between the drinking liquid storage 341 and the first guide cooler 31. The drinking liquid storage 341 may be located out of the housing 100. To an end of the supply pipe 342, the drinking liquid storage 341 may be assembled, while, to the other end of the supply pipe 342, the first guide cooler 31 may be assembled.

The drinking liquid discharger 35 may be coupled to the second guide cooler 32 to discharge drinking liquid therefrom. In one example, the drinking liquid discharger 35 may include a discharge pipe 351 connected to one end of the second guide cooler 32, and a discharge adjuster 352 to adjust an discharge amount of drinking liquid, for example, via manipulation of a valve coupled to the discharge pipe 351.

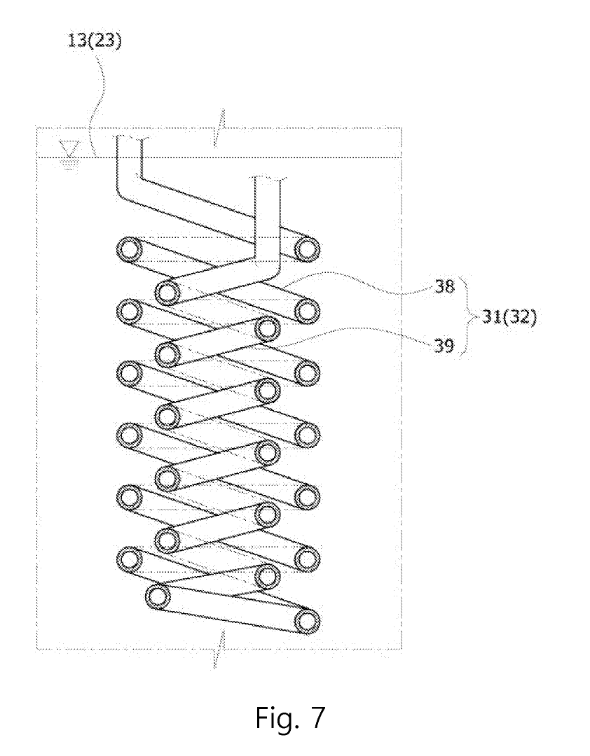

FIG. 7 illustrates a schematic view of a first guide cooler and a second guide cooler of a drinking liquid cooling system in accordance with one embodiment of the present disclosure. Referring to FIG. 1 to FIG. 7, each of the first guide cooler 31 and the second guide cooler 32 may be formed of a pipe shape to guide drinking liquid. Each of the first guide cooler 31 and the second guide cooler 32 may be formed of a double spiral shape. Thus, each of the first guide cooler 31 and the second guide cooler 32 may have an increased contact area with the first cooling water 13 and the second cooling water 23 respectively. To be specific, each of the first guide cooler 31 and the second guide cooler 32 may have an outer spiral portion 38 to downwardly extend from a top thereof in a spiral shape, and an inner spiral portion 39 to upwardly extend from a bottom of the outer spiral portion 38 in a spiral shape. In this case, the inner spiral portion 39 may be disposed within the outer spiral portion 38. In an alternative, each of the first guide cooler 31 and the second guide cooler 32 may have an inner spiral portion to downwardly extend from a top thereof in a spiral shape, and an outer spiral portion to upwardly extend from a bottom of the inner spiral portion in a spiral shape.

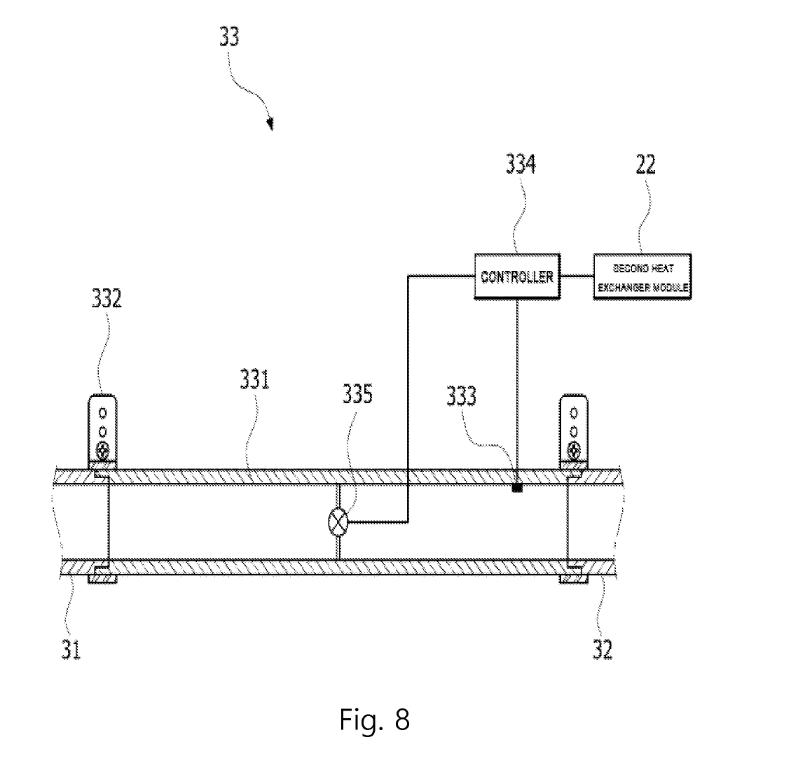

FIG. 8 illustrates a schematic view of a guide connector of a drinking liquid cooling system in accordance with one embodiment of the present disclosure. Referring to FIG. 1 to FIG. 8, the guide connector 33 in accordance with one embodiment of the present disclosure may include a connection pipe 331 and a connection fastener 332.

The connection pipe 331 may have both open ends. To one end thereof, the first guide cooler 31 may be coupled, while to the other end thereof, the second guide cooler 32 may be coupled. In one example, the first guide cooler 31 and the second guide cooler 32 may sandwich the connection pipe 331 therebetween. In one example, the connection pipe 331 may be made of a wrinkled flexible or length-adjustable tube, to be adapted to a varying distance or angle between the first guide cooler 31 and the second guide cooler 32.

The connection fastener 332 may be two; one may fasten one end of the connection pipe 331 to the first guide cooler 31, while the other may fasten the other end thereof to the second guide cooler 32. In one example, each of the connection fasteners 332 may be implemented as a sealing member to suppress a water leak from each of connection portions between the first guide cooler 31 and connection pipe 331, and between the second guide cooler 32 and connection pipe 331. In an alternative, each of the connection fasteners 332 may be formed of a screw-like fastener. In this connection, a corresponding screw-like fastener may wrap each of connection portions between the first guide cooler 31 and connection pipe 331, and between the second guide cooler 32 and connection pipe 331.

The guide connector 33 in accordance with one embodiment of the present disclosure may further include a sensor 333, a controller 334, and a valve 335. The sensor 333 may be embedded in the connection pipe 331 to sense a current drinking liquid temperature, and to send the measured temperature to the controller 334. The valve 335 may be configured to open or close the connection pipe 331 via control of the controller 334. In this connection, when the sensed drinking liquid temperature from the sensor 333 is significantly different from the pre-defined temperature, the valve 335 may allow the connection pipe 331 to be blocked. Thus, after drinking liquid is sufficiently cooled by the first cooler 10, the drinking liquid may move to the second cooler 20.

In this connection, the second heat exchanger module 22 may be configured to adjust the second cooling water 23 temperature via control of the controller 223. To be specific, when a current drinking liquid temperature in the connection pipe 331 is higher than the pre-defined temperature, the second heat exchanger module 22 may be configured to cool the second cooling water 23 to lower the drinking liquid temperature therein. To the contrary, when a current drinking liquid temperature in the connection pipe 331 is lower than the pre-defined temperature, the second heat exchanger module 22 may be configured to heat the second cooling water 23 to raise the drinking liquid temperature therein. In this way, the drinking liquid to be discharged may always have the pre-defined temperature.

Hereinafter, an operation of the drinking liquid cooling system in accordance with one embodiment of the present disclosure will be described below.

First, the first heat exchanger module 12 may enable cooling of the first cooling water 13 in the first water reservoir 11, and the second heat exchanger module 22 may enable adjustment of temperature of the second cooling water 23 in the second water reservoir 12. In this connection, the first water reservoir 11 may receive therein the first guide cooler 31, while the second water reservoir 12 may receive therein the second guide cooler 32. The first guide cooler 31 and the second guide cooler 32 may be coupled to each other via the guide connector 33.

Thereafter, when the user manipulates the discharge adjuster 352, drinking liquid in the drinking liquid storage 341 may be fed into the first guide cooler 31 and, then, the second guide cooler 32, and, then, may be discharged from the drinking liquid discharger 35.

The first water reservoir 11 may contain the first cooling water 13 containing ices, which may contact the first guide cooler 31. Using the first heat exchanger module 12, a temperature of the first cooling water 13 may be adjusted. The first heat exchanger module 12 may cool the first cooling water 13 to rapidly cool drinking liquid currently passing through the first guide cooler 31.

The second water reservoir 21 may contain the second cooling water 23, which may contact the second guide cooler 32. Using the second heat exchanger module 22, a temperature of the second cooling water 23 may be adjusted. The second heat exchanger module 12 may adjust the second cooling water 13 such that a temperature of drinking liquid currently passing through the second guide cooler 32 may be kept at the pre-defined temperature.

In this way, drinking liquid passing through the first guide cooler 31 may be rapidly cooled using the first cooler 10, and, thereafter, may pass through the second guide cooler 32 where the drinking liquid may have the pre-defined temperature. Thus, the user may always drink the drinking liquid always at the pre-defined temperature.

The guide connector 33 may be coupled to the first guide cooler 31 and the second guide cooler 32 at both open ends thereof. Thus, if desired, the guide connector 33 may be disconnected from the first guide cooler 31 and the second guide cooler 32 for cleaning thereof.

The sensor 333 embedded in the guide connector 33 may sense the drinking liquid temperature currently passing through the connection pipe 331. For example, it may be assumed that the pre-defined temperature is set to about 4° C. range. When the drinking liquid temperature measured by the sensor 333 is in a range of the pre-defined temperature, that is, for example, between 3° C. and 5° C., the second heat exchanger module 22 may work based on the range of the pre-defined temperature. Thus, a temperature of the second cooling water 23 may be adjusted based on the range of the pre-defined temperature, such that drinking liquid passing through the second guide cooler 32 may be kept at the pre-defined temperature.

Otherwise, when the drinking liquid temperature measured by the sensor 333 is out of a range of the pre-defined temperature, that is, for example, below 3° C. or above 5° C., the controller may determine a system failure or an abnormal operation of the first cooler 10, and, thus, may block the connection pipe 331. When the connection pipe 331 is blocked, this may be informed of the user via a separate alarm function. In an alternative, just after discharging excessive drinking liquid, the connection pipe 331 may be blocked for a predetermined time, such that a flow of the drinking liquid may stop until the first heat exchanger module 12 again cools the first cooling water 13.

Using the drinking liquid cooling system 1 in accordance with one embodiment of the present disclosure, drinking liquid may be rapidly cooled by the first cooler 10, and, then, may reach the pre-defined temperature using the second cooler 20. Thus, the user may always have drinking liquid with a constant temperature.

With the drinking liquid cooling system 1 in accordance with one embodiment of the present disclosure, each of the first guide cooler 31 31 and the second guide cooler 32 may have inner and outer spirally-extending structures, wherein the inner and outer spirally-extending structures are spaced from each other. This may allow the first guide cooler 31 and the second guide cooler 32 to have enlarged contact areas with the first cooling water 13 and the second cooling water 23 respectively. Thus, a thermal conductance therebetween may be enhanced.

Using the drinking liquid cooling system 1 in accordance with one embodiment of the present disclosure, the sensor 333 may sense the temperature of drinking liquid currently passing through the connection pipe 331 and send the same to the controller 334, and, then, the controller 334 may instruct the valve 335 to open or close the connection pipe 331 based on the measured temperature.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A drinking liquid cooling system comprising:
a first cooler configured to cool drinking liquid;
a second cooler configured to allow the drinking liquid from the first cooler to have a pre-defined temperature; and
a drinking liquid guider configured to guide the drinking liquid via the first cooler and, then, via the second cooler and, then, to allow the drinking liquid to be discharged.

2. The system of claim 1, wherein the first cooler comprises:
a first water reservoir configured to contain therein a first cooling water, and allow the drinking liquid guider to pass therethrough; and
a first heat exchanger module configured to cool the first cooling water.

3. The system of claim 2, wherein the second cooler comprises:
a second water reservoir configured to contain therein a second cooling water, and allow the drinking liquid guider to pass therethrough; and
a second heat exchanger module configured to allow the second cooling water to have the pre-defined temperature.

4. The system of claim 3, wherein the drinking liquid guider comprises:
a first guide cooler received in the first water reservoir, and contacting the first cooling water;
a second guide cooler received in the second water reservoir, and contacting the second cooling water;
a guide connector configured to connect the first guide cooler and the second guide cooler with each other, and, thus, to guide the drinking liquid from the first guide cooler to the second guide cooler;
a drinking liquid supply coupled to the first guide cooler to supply the drinking liquid to the first guide cooler; and
a drinking liquid discharger coupled to the second guide cooler to discharge the drinking liquid.

5. The system of claim 4, wherein each of the first guide cooler and the second guide cooler has inner and outer spirally-extending structures, wherein the inner and outer spirally-extending structures are spaced from each other.

6. The system of claim 4, wherein the guide connector comprises:
a connection pipe having both open ends coupled to the first guide cooler and the second guide cooler respectively; and
connection fasteners, each connection fastener being configured to fasten the both ends of the connection pipe to the first guide cooler and the second guide cooler respectively.

7. The system of claim 6, wherein the guide connector comprises:
a sensor embedded in the connection pipe and configured to sense a temperature of the drinking liquid currently passing through the connection pipe;
a controller configured to receive the sense temperature from the sensor; and
a valve mounted to the connection pipe, and configured to open or close the connection pipe under control of the controller.

8. The system of claim 7, wherein the second heat exchanger module is configured to adjust a temperature of the second cooling water under control of the controller.
